(19) United States
(12) Patent Application Publication
(10) Pub. No.: US 2025/0039913 A1
(43) Pub. Date: Jan. 30, 2025

(54) EFFICIENT SCHEME FOR SUPPRESSION OF BASE STATION NON-LINEARITY

(71) Applicant: QUALCOMM Incorporated, San Diego, CA (US)

(72) Inventors: Aviv REGEV, Tel Aviv (IL); Ronen SHAKED, Kfar Saba (IL)

(21) Appl. No.: 18/357,969

(22) Filed: Jul. 24, 2023

(51) Int. Cl. H04W 72/54

(52) U.S. Cl. CPC H04W 72/54

(57) ABSTRACT

An efficient scheme for suppression of base station NL is described. An apparatus is configured to provide, for a network node, an SNR indication for signals associated with the network node. The apparatus is configured to receive, from the network node, a NL indication based on the SNR indication, where the NL indication indicates an activation or deactivation of NL cancelation for the UE, and to demodulate data based on the NL indication. Another apparatus is configured to receive, from a UE, an SNR indication for signals associated with the network node. The apparatus is configured to provide, for the UE, a NL indication based on at least one of the SNR indication, a NL distortion level associated with the network node, or a thermal noise level associated with the network node, where the NL indication indicates an activation or deactivation of NL cancelation for the UE.

### TECHNICAL FIELD

The present disclosure relates generally to communication systems, and more particularly, to wireless communications utilizing non-linearity processing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at a UE. The apparatus is configured to provide, for a network node, a signal-to-noise ratio (SNR) indication for at least one signal associated with the network node. The apparatus is also configured to receive, from the network node, a non-linearity (NL) indication that is based on the SNR indication, where the NL indication indicates an activation or a deactivation of NL cancelation for the UE. The apparatus is also configured to demodulate data based on the NL indication.

In the aspect, the method includes providing, for a network node, an SNR indication for at least one signal associated with the network node. The method also includes receiving, from the network node, a NL indication that is based on the SNR indication, where the NL indication indicates an activation or a deactivation of NL cancelation for the UE. The method also includes demodulating data based on the NL indication.

In another aspect of the disclosure, a method, a computer-readable medium, and an apparatus are provided. The apparatus is configured to receive, from a UE, an SNR indication for at least one signal associated with the network node. The apparatus is also configured to provide, for the UE, a NL indication that is based on at least one of the SNR indication, a NL distortion level associated with the network node, or a thermal noise level associated with the network node, where the NL indication indicates an activation or a deactivation of NL cancelation for the UE.

In the other aspect, the method includes receiving, from a UE, an SNR indication for at least one signal associated with the network node. The method also includes providing, for the UE, a NL indication that is based on at least one of the SNR indication, a NL distortion level associated with the network node, or a thermal noise level associated with the network node, where the NL indication indicates an activation or a deactivation of NL cancelation for the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of default NL cancelation by a UE.

FIG. 5 is a call flow diagram for wireless communications, in accordance with various aspects of the present disclosure.

FIG. 6 is a diagram illustrating an example of determining a NL distortion/noise level, in accordance with various aspects of the present disclosure.

FIG. 7 is a diagram illustrating an example of determining a NL distortion/noise level, in accordance with various aspects of the present disclosure.

FIG. 8 is a diagram illustrating an example of NL indication determinations, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks, such as an LTE network and/or a 5G NR network, among other examples of wireless communication networks, may be designed to support communications between network nodes (e.g., base stations, gNBs, etc.) and UEs. Network nodes may provide communication signaling with NL impairments. The NL impairment at network node power amplifier (PA) antennas limits the data transmission rate for communications. This can become more dominant in higher frequency bands (e.g., millimeter wave (mmW) and sub-THz bands) that have poor PA efficiency (e.g., as low as 15%). Hence, when it is desired to improve this efficiency, such as by an increase of transmit power at the network node, the side effect is increased non-linearity from the transmitting PA. Some solutions with advanced receivers (e.g., at UEs) may be configured to handle distortion associated with the NL impairment with NL cancelation such as estimation and correction, which may include using digital post distortion (DPoD) or other NL cancelation strategies.

However, this NL cancelation process consumes power and can increase latency in the detection process at the UE. UEs may cancel NL distortion by default, regardless of the NL level with respect to the channel condition (e.g., SNR, error vector magnitude (EVM) that may be 1/SNR, etc.). Aspects presented herein enable the UE receiver to determine whether the dominating noise floor it is experiencing is due to thermal noise or due to the NL noise. In the latter case, where NL noise is the dominant NL impairment factor, and not in the former case of thermal noise contributions, there is a benefit for the UE trying of estimating and cancelling the NL impairment. However, when the NL noise is not the dominant factor, rather thermal noise is dominant or NL noise is inconsequential, the NL cancelation process may not improve the total SNR/EVM, and the UE expends resources and time (e.g., increases power consumption and latency). Aspects presented herein enable a UE to refrain from NL correction in scenarios where it may be redundant/less effective and would not sufficiently improve the total SNR/EVM, e.g., when the NL impairment appears to be negligible with respect to channel conditions. Furthermore, even if the NL distortion/noise level is not negligible, but the UE receiver is able achieve an EVM (or SNR) that is sufficient to handle the current modulation and coding scheme (MCS) decoding. NL cancelation at the UE may be unnecessary.

Various aspects relate generally to wireless communications systems that utilize non-linearity processing. Some aspects more specifically relate to an efficient scheme for suppression of base station non-linearity. In one example, a UE may be configured to provide, for a network node, an SNR indication for at least one signal associated with the network node. The UE may be configured to receive, from the network node, a NL indication that is based on the SNR indication, where the NL indication indicates an activation or a deactivation of NL cancelation for the UE. The UE may be configured to demodulate data based on the NL indication. In another example, a network node (e.g., a base station, gNB, etc.) may be configured to receive, from a UE, an SNR indication for at least one signal associated with the network node. The network node may be configured to provide, for the UE, a NL indication that is based on at least one of the SNR indication, a NL distortion level associated with the network node, or a thermal noise level associated with the network node, where the NL indication indicates an activation or a deactivation of NL cancelation for the UE. The network node may be configured to determine its actual NL distortion/noise level based on the SNR indication and a thermal noise level of the PA(s) of the network node.

Particular aspects of the subject matter described in this disclosure can be implemented to realize one or more of the following potential advantages. In one example, by determining an actual NL distortion/noise level based on an SNR indication(s) and a thermal noise level of the PA(s) of the network node, the described techniques can be used to indicate to a UE whether to activate/deactivate NL suppression in order to apply such NL suppression for scenarios where it is beneficial and conserve UE resources/improve latency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

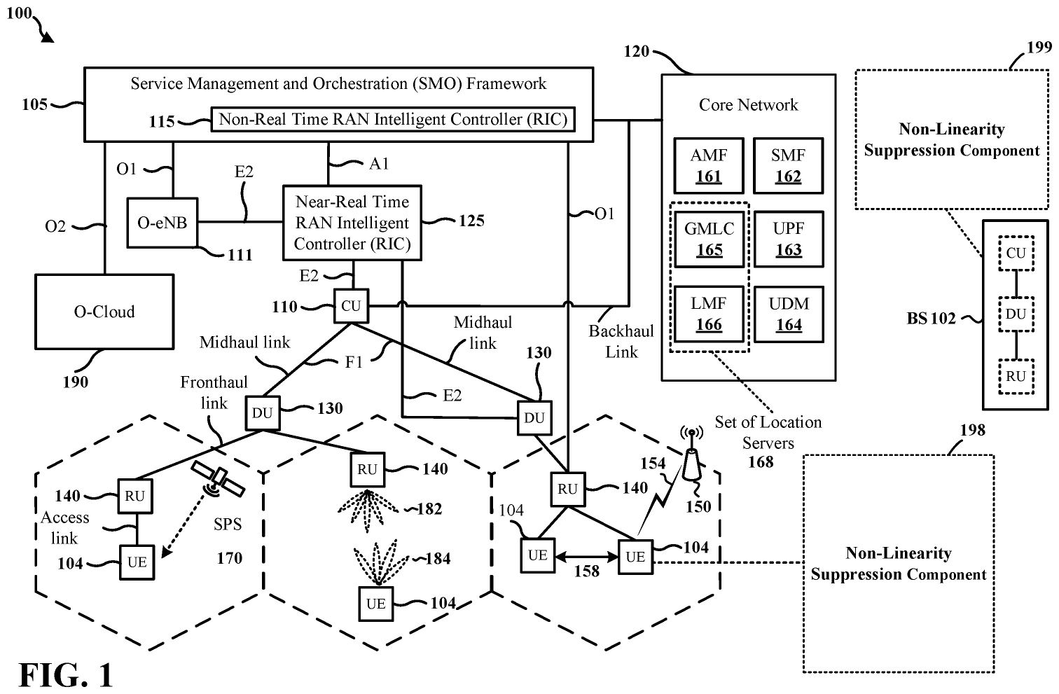

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUS 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a non-linearity suppression component 198 (“component 198”) that may be configured to provide, for a network node, an SNR indication for at least one signal associated with the network node. The component 198 may also be configured to receive, from the network node, a NL indication that is based on the SNR indication, where the NL indication indicates an activation or a deactivation of NL cancelation for the UE. The component 198 may also be configured to demodulate data based on the NL indication. The component 198 may be configured to receive the data, from the network node, using a physical downlink shared channel (PDSCH). In certain aspects, the base station 102 may have non-linearity suppression component 199 (“component 199”) that may be configured to receive, from a UE, an SNR indication for at least one signal associated with the network node. The component 199 may also be configured to provide, for the UE, a NL indication that is based on at least one of the SNR indication, a NL distortion level associated with the network node, or a thermal noise level associated with the network node, where the NL indication indicates an activation or a deactivation of NL cancelation for the UE. The component 199 may be configured to obtain an initial NL distortion level associated with the network node. The component 199 may be configured to obtain the thermal noise level associated with the network node based on the initial NL distortion level and the SNR indication. The component 199 may be configured to calculate the NL distortion level based on the initial NL distortion level and the thermal noise level. The component 199 may be configured to calculate the NL distortion level based on the SNR indication and the at least one additional SNR indication. Thus, aspects herein enable a network node (e.g., a base station, a gNB, etc.) to determine whether its power amplifier has a NL impairment based more on thermal noise or on NL distortion/noise and indicate to a UE to activate/deactivate NL cancelation accordingly, which reduces power consumption and latency in the detection process.

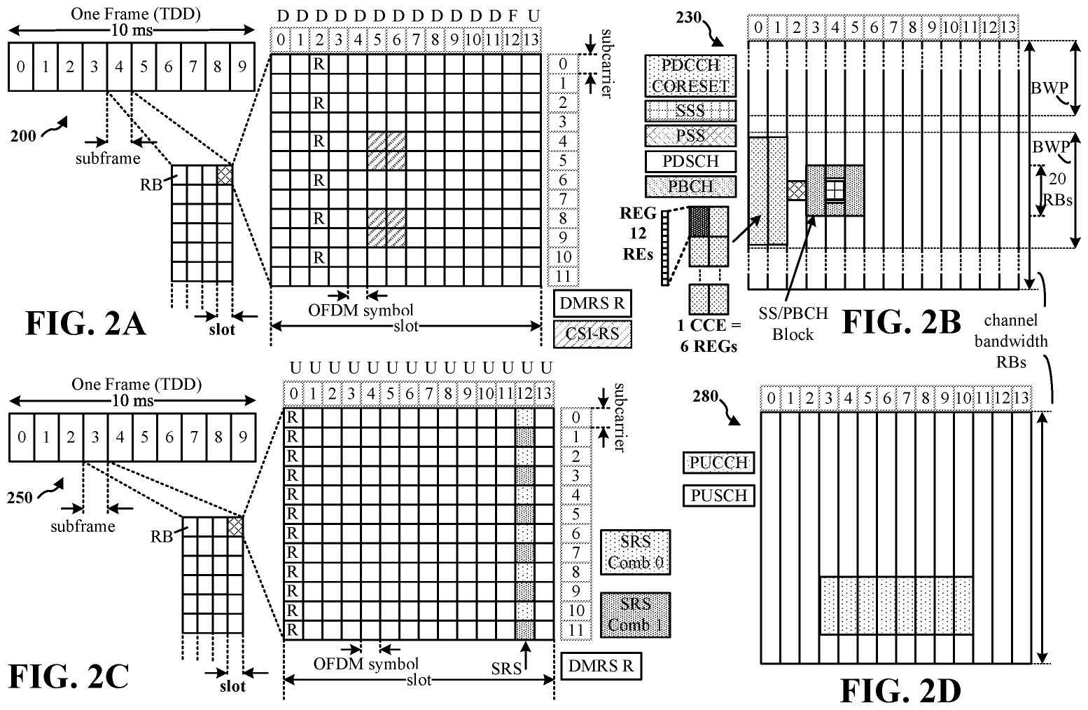

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

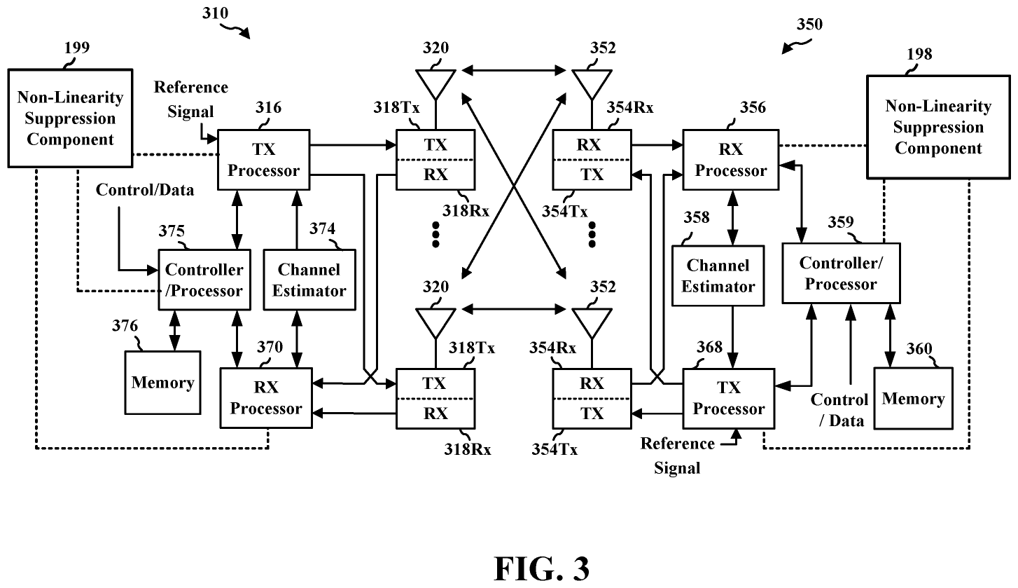

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

For communications between network nodes (e.g., base stations, gNBs, etc.) and UEs, network nodes may provide communication signaling with NL impairments. The NL impairment at network node PA antennas is known as an impairment that limits the data transmission rate for communications. This can become more dominant in higher frequency bands (e.g., mmW and sub-THz bands) that have poor PA efficiency (e.g., as low as 15%). Hence, when the transmit power is increased at the network node to improve the PA efficiency, the side effect may be increased non-linearity from the transmitting PA. Some solutions for advanced receivers (e.g., at UEs) may be configured to handle distortion associated with the NL impairment with NL cancelation such as estimation and correction, which may include using DPoD or other NL cancelation strategies. However, this NL cancelation process consumes power consumption and latency in the detection process at the UE. UEs may cancel NL distortion by default, regardless of the NL level with respect to the channel condition (e.g., SNR, EVM, etc.). In order to improve the efficiency and accuracy of wireless communication, aspects presented herein enable the UE receiver to determine whether the dominating noise floor it is experiencing is due to thermal noise or due to the NL noise. In the latter case, where NL noise is the dominant NL impairment factor, and not in the former case of thermal noise contributions, there is a benefit for the UE trying of estimating and cancelling the NL impairment. However, when the NL noise is not the dominant factor, rather thermal noise is dominant or NL noise is inconsequential, the NL cancelation process may not improve the total SNR/EVM, and the UE expends resources and time (e.g., increases power consumption and latency). Aspects presented herein enable a UE to refrain from NL correction in scenarios where it would be redundant/ineffectual and would not sufficiently improve the total SNR/EVM, e.g., when the NL impairment appears to be negligible with respect to channel conditions. Furthermore, even if the NL distortion/noise level is not negligible, but the UE receiver is able achieve an EVM (or SNR) that is sufficient to handle the current MCS decoding. NL cancelation at the UE may be unnecessary.

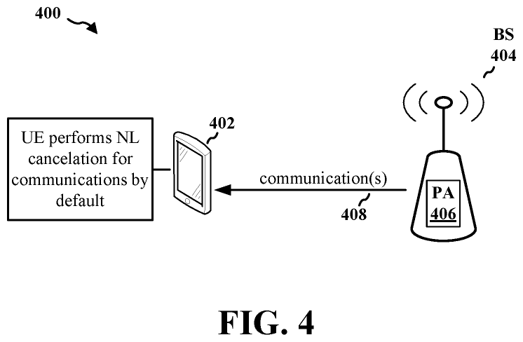

FIG. 4 is a diagram 400 illustrating an example of default NL cancelation by a UE. Diagram 400 shows a UE 402 that communicates with a base station 404. The base station 404 transmit communications 408 to the UE 402 using a PA 406. As noted herein, the UE 402 may experience NL distortion associated with the PA 406 of the base station 404. To alleviate this NL distortion, the UE 402 is configured, by default, to perform NL cancelation for the communications 408, even in scenarios when the NL distortion from the PA 406 mainly composed of thermal noise and/or when the NL distortion is not significant enough to prevent decoding of the MCS used for the communications 408.

In other words, whether or not the NL cancelation performed by the UE 402 provides a detectable, or any, benefit for the SNR/EVM, the UE 402 estimates and attempts to cancel the NL impairment from the PA 406, in order to try and improve the total SNR/EVM, as the default operation of the UE 402. This may lead to increased power usage and latency due to the estimation and processing performed by the UE 402, even for scenarios in which the NL cancelation does not provide a detectable, or any, benefit for the SNR/EVM.

Various aspects herein for an efficient scheme for suppression of base station non-linearity enable network nodes to determine the actual NL distortion/noise level based on SNR indications and thermal noise levels of Pas of the network node. Indications may be provided to a UE whether to activate/deactivate NL suppression in order to apply such NL suppression for scenarios where it is beneficial and conserve UE resources/improve latency by determining an actual NL distortion/noise level based on an SNR indication(s) and a thermal noise level of the PA(s) of the network node. Accordingly, aspects herein may be associated with DPoD and provide for adding a signal to let the a UE know whether applying DPoD or other NL cancelation is desired/beneficial or not based on the UE SNR. For nearby UEs having high thermal SNR, applying DPoD at a UE receiver might be desired, while for further away UEs, which suffer low thermal noise, applying DPoD may be wasteful and not desired/beneficial. The aspects herein may avoid a wasteful estimation and correction processes (e.g., that consume additional power and/or increase latency) in scenarios for which the NL distortion/noise level is negligible with respect to the channel conditions (e.g., SNR/EVM—the terms SNR and EVM may be used interchangeably for the description herein, as would be understood by one of skill in the relevant art(s) having the benefit of this disclosure), and/or for which the reported, measured total SNR (e.g., even without applying NL correction) is already sufficient to successfully demodulate the current MCS. To detect those scenarios, the base station/gNB may be configured to measure its NL impairment level and compare it to the reported total SNR. If one of the two scenarios is met, then the base station/gNB may be configured to provide messages to the UE(s) to disable NL estimation and correction, and thus, refrain from a wasteful and/or unnecessary power consumption and increased latency for the UE receiver decoding process.

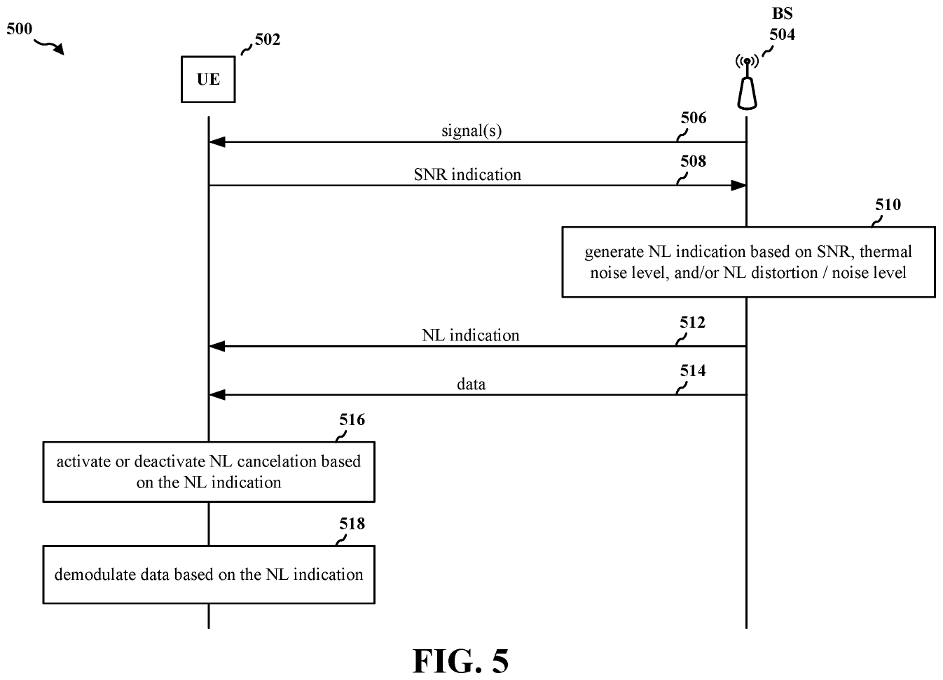

FIG. 5 is a call flow diagram 500 for wireless communications, in accordance with various aspects of the present disclosure. Call flow diagram 500 illustrates an efficient scheme for suppression of network node NL (e.g., base station/gNB NL) at a wireless device (a UE 502, by way of example) that communicates with the network node (a base station 504, such as a gNB or other type of base station, by way of example, as shown), in various aspects. Aspects described for the base station 504 may be performed by the base station in aggregated form and/or by one or more components of the base station in disaggregated form. Additionally, or alternatively, the aspects may be performed by the UE 502 autonomously, in addition to, and/or in lieu of, operations of the base station 504. The base station 504 may be configured to with a PA (not shown) that is utilized to transmit signals for the UE 502.

In the illustrated aspect, the UE 502 may be configured to receive a signal(s) 506, which the base station 504 may be configured to transmit/provide. The UE 502 may be configured to determine/measure an SNR for the received signal(s) 506 from the base station 504. The UE 502 may then be configured to transmit/provide an SNR indication 508, which the base station 504 may be configured to receive. In aspects, the SNR indication 508 may be associated with a prior activation of NL cancelation at the UE 502. In such aspects, the SNR indication 508 may be associated with a corresponding quality metric that indicates an accuracy of a NL distortion level at the PA of the base station 504. Accordingly, the base station 504 may obtain the SNR indication 508 that indicates an SNR(s) for at least one signal associated therewith (e.g., the signal(s) 506).

The base station 504 may be configured to generate (at 510) a NL indication 512. The NL indication 512 may be generated (at 510) based on an SNR(s) indicated in the SNR indication 508, a thermal noise level at the base station 504 (e.g., for a PA of the base station 504 utilized to transmit/provide the signal(s) 506), and/or a NL distortion/noise level (e.g., for the PA of the base station 504). In aspects, the NL distortion level (e.g., the NL noise level) of a PA for the base station 504 may be configured for the base station 504 (e.g., by an OEM thereof, such as with factory calibration), may be calculated based on the SNR(s) indicated in the SNR indication 508, and/or may be calculated based on SNRs indicated by two or more UEs (e.g., the UE 502 and an additional UE, as described in further detail below) that have implemented NL cancelation for a signal(s) transmitted/provided by the base station 504 (e.g., these signal(s) for the SNRs may include the signal(s) 506, when NL cancelation is applied by the UE 502). The thermal noise level of a PA may be extracted from the SNR indicated in the SNR indication 508. In aspects, the thermal noise level may be determined by subtracting the NL distortion/noise level from the SNR or corresponding EVM.

The NL indication 512 may indicate an activation or a deactivation of NL cancelation for the UE 502. The base station 504 may be configured to transmit/provide the NL indication 512, which the UE 502 may be configured to receive (e.g., using a PDCCH). In aspects, the NL indication 512 may indicate the deactivation of the NL cancelation for the UE 502 based on the thermal noise level associated with the PA of the base station 504 meeting a threshold condition, while the NL indication 512 may indicate the activation of the NL cancelation for the UE 502 based on the thermal noise level associated with the base station 504 failing to meet the threshold condition, in other aspects. In some aspects, the threshold condition may be associated with an increase to an SNR, which corresponds to the SNR indication 508, relative to the SNR. In aspects, the NL indication 512 may indicate the deactivation of the NL cancelation for the UE 502 based on an SNR, which corresponds to the SNR indication 508, meeting a threshold condition, while the NL indication 512 may indicate the activation of the NL cancelation for the UE 502 based on the SNR that corresponds to the SNR indication 508 failing to meet the threshold condition. The threshold condition may, in such cases, be an SNR value associated with the ability of the UE 502 to properly decode a MCS utilized for communications with the base station 504.

The base station 504 may be configured to transmit/provide data 514, which the UE 502 may be configured to receive. The data 514 may be included with a transmission for the UE 502 that is received using a PDSCH. The UE 502 may be configured to activate or deactivate (at 516) NL cancelation at the UE 502 based on the NL indication 512, as noted above. The UE 502 may then be configured to demodulate (at 518) the data 514 based on the NL indication 512. That is, the UE 502 may be configured to demodulate (at 518) the data 514 with NL cancelation activated or with NL cancelation deactivated (as performed at 516) according to the NL indication 512. In aspects where the NL indication 512 indicates activation and the NL cancelation is activated (at 516), the UE may be configured to demodulate (at 518) the data based on DPoD processing at the UE 502.

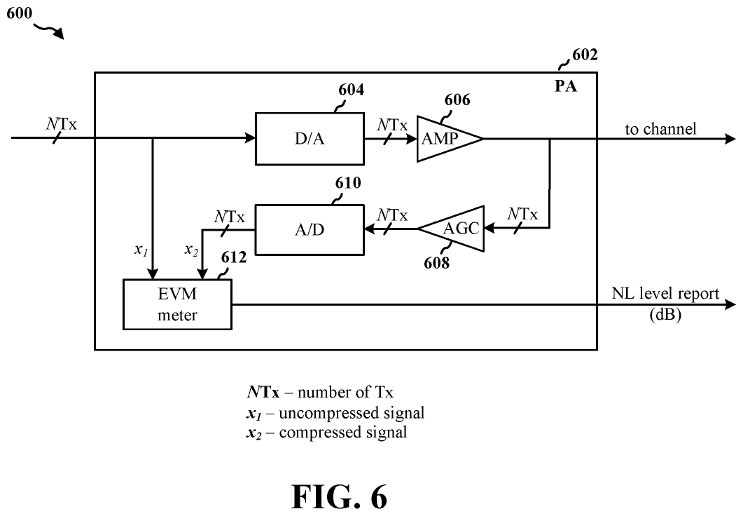

FIG. 6 is a diagram 600 illustrating an example of determining a NL distortion/noise level, in accordance with various aspects of the present disclosure. Diagram 600 illustrates a PA 602 of a network node (e.g., a base station, gNB, etc.) having a number N of transmitters (Tx) shown as NTx. The aspects shown in diagram 600 may represent a feedback chain per Tx PA for each of the NTx. That is, the PA 602 may represent one or more PAs of a base station.

Each Tx may utilize a digital-to-analog converter (D/A) 604 that converts the digital Tx input of the PA 602 into an analog representation thereof. The output of the D/A 604 may be provided to an amplifier (AMP) 606 configured to amplify the analog representation. The output of the AMP 606 may be provided to a channel for transmission to a UE. In aspects, the output of the AMP 606 may also be provided to a feedback chain, beginning with an automatic gain control (AGC) 608 followed by an analog-to-digital converter (A/D) 610 that may be configured to convert the analog representation output of the AMP 606/AGC 608 back to a digital representation of the signal. This digital representation may be a compressed signal representation and may be provided to an EVM meter 612, along with the original, uncompressed input to the PA 602 for the Tx, to perform an comparison thereof. That is, the base station may perform a real time, or near real time, NL measurement (e.g., at a low rate) using the EVM meter 612 to determine the actual NL distortion/noise level for a NL level report based on the comparison of the uncompressed (x₁) digital input to the PA and the compressed (x₂) representation of the analog signal.

Based on the NL level report the thermal noise level component of the overall NL distortion may be determined/calculated by subtracting the NL distortion/noise level from a reported SNR/EVM.

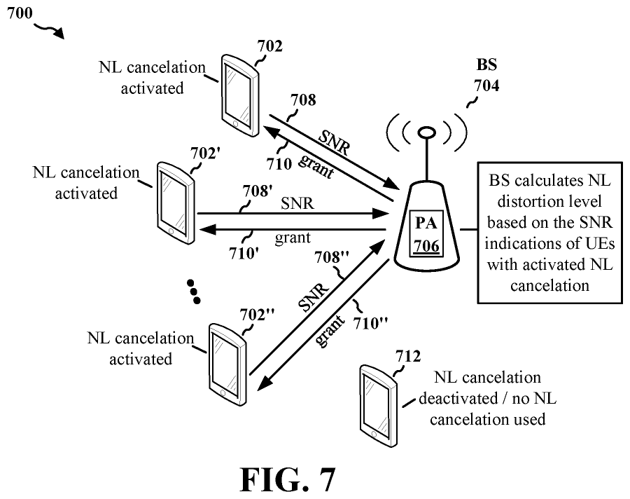

FIG. 7 is a diagram 700 illustrating an example of determining a NL distortion/noise level, in accordance with various aspects of the present disclosure. Diagram 700 shows a number of UEs (e.g., a UE 702, a UE 702′, a UE 702″, and a UE 712) that communicate with a base station 704 having a PA 706. In the illustrated aspect, the UE 702, the UE 702′, and the UE 702″ may have NL cancelation activated for at least one signal (e.g., as shown for the signal(s) 506 in FIG. 5) respectively received thereby from the base station 704 using the PA 706, while the UE 712 may have its NL cancelation deactivated or may otherwise have NL cancelation unused.

According to aspects, the UE 702, the UE 702′, and the UE 702″ may each be configured to provide an SNR indication for the received signals from the base station 704 using the PA 706. For example, the base station 704 may provide grants (e.g., a grant 710, a grant 710′, and a grant 710″) to each of the UE 702, the UE 702′, and the UE 702″ (e.g., based on UE requests) to respectively report an SNR 708, an SNR 708′, and an SNR 708″. In aspects, the grant 710, the grant 710′, and the grant 710″ may be provided based on NL cancelation being activated at the respective UEs. In this way, the base station 704 may receive SNR indications from the UE 702, the UE 702′, and the UE 702″ associated with the received signals at the UEs after NL cancelation processing (e.g., an estimated NL level per Tx antenna associated with the PA 706). The base station 704 may be configured to utilize such SNR indications to determine the thermal noise level and/or the NL distortion/noise level at the PA 706.

The base station 704 may be configured to average the NL distortion/noise levels as reported from the UE 702, the UE 702′, and the UE 702″. Each or any of the UE 702, the UE 702′, and the UE 702″ may be configured to assign a quality metric to its SNR report/indication for the NL levels corresponding to the SNR 708, the SNR 708′, and the SNR 708″. The quality metric may indicate how accurate the reported NL level(s) is. In one example, each or any of the UE 702, the UE 702′, and the UE 702″ may be configured to estimate the received SNR for the signal(s) and using that as the quality metric. Thus, the base station 704 may be configured to apply a weighted average between the reports/indications of the UEs for the SNR 708, the SNR 708′, and the SNR 708″. The utilized weight may be the reported quality metric. This may allow for a refreshing of the NL level (e.g., at low rate) to account for variances over time.

Based on the NL distortion/noise level(s) indicated or estimated, the thermal noise level component of the overall NL distortion may be determined/calculated by subtracting the NL distortion/noise level from a reported SNR/EVM.

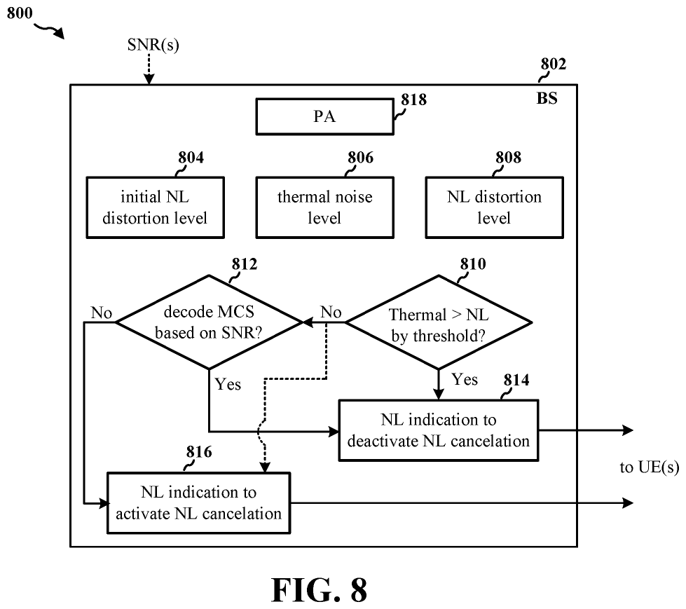

FIG. 8 is a diagram 800 illustrating an example of NL indication determinations, in accordance with various aspects of the present disclosure. Diagram 800 shows a base station 802, having a PA 818, that may be configured to receive SNRs, or indications thereof, from one or more UEs. The base station may obtain, receive, and/or calculate an initial NL distortion level 804, a thermal noise level 806, and/or a NL distortion level 808 for the PA 818. In aspects, the base station 802 may be configured to utilize the initial NL distortion level 804, the thermal noise level 806, and/or the NL distortion level 808 to determine whether NL cancelation at a UE is to be activated or deactivated, as described herein.

In one configuration, the base station 802 may be configured with the NL distortion level 808 (e.g., by an OEM), as noted above in the description for FIG. 5.

In another configuration, the base station 802 may be configured to activate/deactivate NL cancelation at a UE based on the thermal noise level 806 being higher than the NL distortion level 808 by a threshold amount (e.g., in dB). For instance, such a configuration covers scenarios when the NL distortion level 808 is below the noise floor level (e.g., the NL distortion level 808 is not the dominant noise contributing to the SNR). Thus, a NL correction by a UE using NL cancelation would affect the total SNR/EVM by an amount that is not significant for improvements, quality, performance, etc. (e.g., the NL cancelation would yield a negligible improvement). As examples, using a threshold (TH1) of 6 dB, the base station 802 may be configured to determine to waive SNR/EVM improvements smaller than 1 dB, while using TH1=10 dB, the base station 802 may be configured to determine to waive SNR/EVM improvements smaller than 0.5 dB.

As illustrated, the NL distortion level 808 may be determined based on the thermal noise level 806 and an SNR representation by subtracting the thermal noise level 806 from the SNR. The thermal noise level 806 may be determined based on the initial NL distortion level 804, e.g., as configured/determined herein. If the thermal noise level 806 exceeds the NL distortion level 808 by the threshold amount (e.g., meets the threshold condition), the base station 802 may determine (at 810) to provide an NL indication 814 to deactivate NL cancelation at a UE-if not, the base station 802 may determine (at 810) if another scenario warrants deactivation of NL cancelation, or the base station 802 may be configured to provide an NL indication 816 to deactivate NL cancelation at a UE.

In a further configuration, the base station 802 may be configured to activate/deactivate NL cancelation at a UE based on the reported total SNR being sufficient good for successfully decoding the current MCS. For instance, such a configuration covers scenarios when the reported total SNR is more than sufficient to demodulate the operated MCS. For instance, and in the context of a given MCS, the UE/base station 802 may know the threshold SNR that will allow a successful/proper decoding for the MCS. As an example, if the reported SNR already meets or exceeds a threshold SNR (TH2), e.g., in dB, such as TH2=1 dB, then the base station 802 may determine to disable the NL correction at the UE. Such threshold SNRs may be determined offline per MCS and configured for the UE/base station 802, in aspects.

The base station 802 may be configured to determine (at 812) if a successful decoding of the MCS can be performed based on the reported SNR. If so, the base station 802 may determine (at 812) to provide the NL indication 814 to deactivate NL cancelation at a UE-if not, the base station 802 may determine (at 812) to provide the NL indication 816 to activate NL cancelation at a UE.

The base station 802 may perform determinations (e.g., at 812 and/or at 814) alone or in alternate order, according to aspects, and that the illustrated configuration in FIG. 8 is by way of example for clarity of illustration/description. The aspects herein contemplate configurations for which a UE may have NL cancelation activated unless expressly indicated by a base station to deactivate its NL cancelation (e.g., via a NL indication such as the NL indication 814).

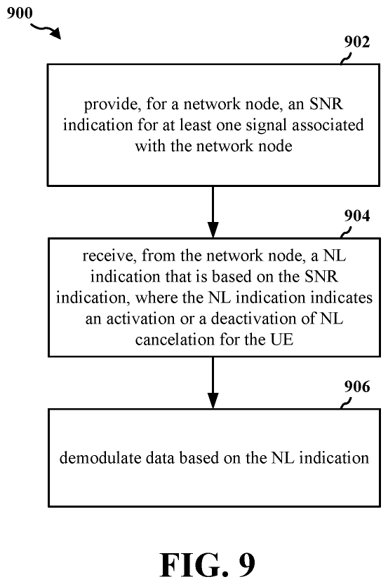

FIG. 9 is a flowchart 900 of a method of wireless communication, in various aspects. The method may be performed by a UE (e.g., the UE 104, 502, 702, 702′, 702″, 712; the apparatus 1104). In some aspects, the method may include aspects described in connection with the communication flow in FIG. 5 and/or aspects described in FIGS. 6, 7, 8. The method may be for an efficient scheme for suppression of base station NL and enables a network node (e.g., a base station, a gNB, etc.) to determine whether its power amplifier has a NL impairment based more on thermal noise or on NL distortion/noise and indicate to a UE to activate/deactivate NL cancelation accordingly, which reduces power consumption and latency in the detection process.

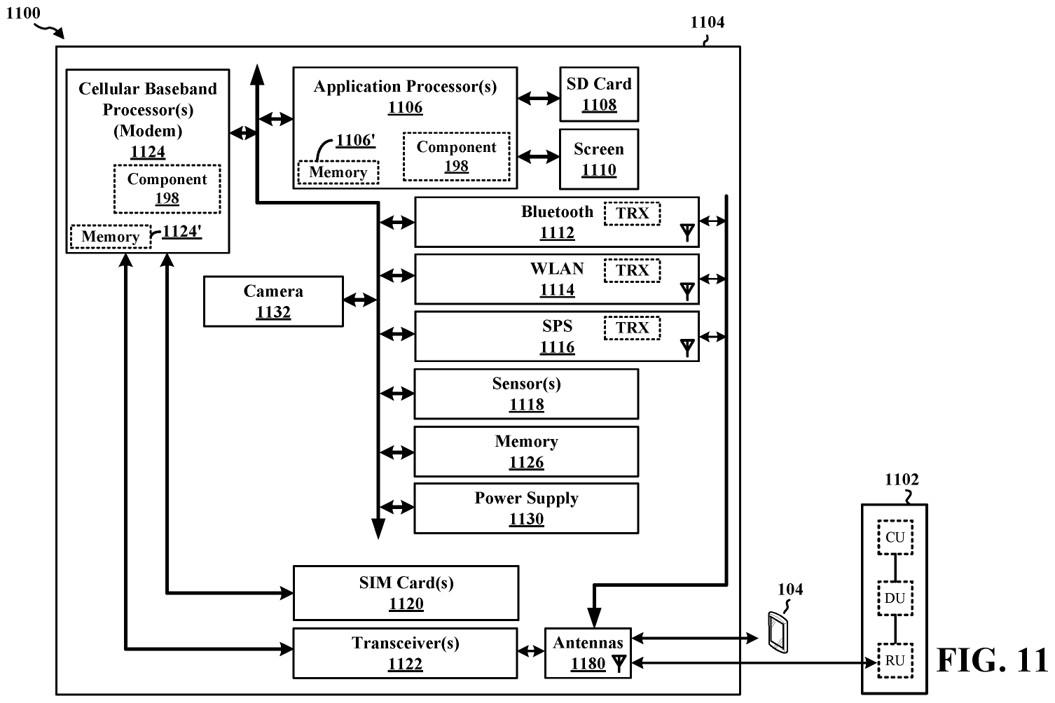

At 902, the UE provides, for a network node, an SNR indication for at least one signal associated with the network node. As an example, the provision may be performed by one or more of the component 198, the transceiver 1122, and/or the antenna 1180 in FIG. 11. FIGS. 5-8 illustrates an example of the UE 502 providing such an SNR indication for a network node (e.g., the base station 504).

The UE 502 may be configured to receive a signal(s) 506, which the base station 504 may be configured to transmit/provide. The UE 502 may be configured to determine/measure an SNR for the received signal(s) 506 from the base station 504. The UE 502 may then be configured to transmit/provide an SNR indication 508 (e.g., 708, 708′, 708″ in FIG. 7; SNR(s) in FIG. 8), which the base station 504 may be configured to receive. In aspects, the SNR indication 508 (e.g., 708, 708′, 708″ in FIG. 7; SNR(s) in FIG. 8) may be associated with a prior activation of NL cancelation at the UE 502. In such aspects, the SNR indication 508 (e.g., 708, 708′, 708″ in FIG. 7; SNR(s) in FIG. 8) may be associated with a corresponding quality metric that indicates an accuracy of a NL distortion level (e.g., 808 in FIG. 8) at the PA (e.g., 602 in FIG. 6; 706 in FIG. 7; 818 in FIG. 8) of the base station 504. Accordingly, the base station 504 may obtain the SNR indication 508 (e.g., 708, 708′, 708″ in FIG. 7; SNR(s) in FIG. 8) that indicates an SNR(s) for at least one signal associated therewith (e.g., the signal(s) 506).

At 904, the UE receives, from the network node, a NL indication that is based on the SNR indication, where the NL indication indicates an activation or a deactivation of NL cancelation for the UE. As an example, the reception may be performed by one or more of the component 198, the transceiver 1122, and/or the antenna 1180 in FIG. 11. FIG. 5 illustrates an example of the UE 502 receiving such a NL indication from a network node (e.g., the base station 504).

The base station 504 may be configured to generate (at 510) a NL indication 512 (e.g., 814, 816 in FIG. 8). The NL indication 512 (e.g., 814, 816 in FIG. 8) may be generated (at 510) based on an SNR(s) indicated in the SNR indication 508 (e.g., 708, 708′, 708″ in FIG. 7; SNR(s) in FIG. 8), a thermal noise level (e.g., 806 in FIG. 8) at the base station 504 (e.g., for a PA (e.g., 602 in FIG. 6; 706 in FIG. 7; 818 in FIG. 8) of the base station 504 utilized to transmit/provide the signal(s) 506), and/or a NL distortion/noise level (e.g., 808 in FIG. 8) (e.g., for the PA (e.g., 602 in FIG. 6; 706 in FIG. 7; 818 in FIG. 8) of the base station 504). In aspects, the NL distortion level (e.g., 808 in FIG. 8) (e.g., the NL noise level) of a PA (e.g., 602 in FIG. 6; 706 in FIG. 7; 818 in FIG. 8) for the base station 504 may be configured for the base station 504 (e.g., by an OEM thereof, such as with factory calibration), may be calculated based on the SNR(s) indicated in the SNR indication 508 (e.g., 708, 708′, 708″ in FIG. 7; SNR(s) in FIG. 8), and/or may be calculated based on SNRs indicated by two or more UEs (e.g., the UE 502 and an additional UE, as described in further detail below) that have implemented NL cancelation for a signal(s) transmitted/provided by the base station 504 (e.g., these signal(s) for the SNRs may include the signal(s) 506, when NL cancelation is applied by the UE 502). The thermal noise level (e.g., 806 in FIG. 8) of a PA (e.g., 602 in FIG. 6; 706 in FIG. 7; 818 in FIG. 8) may be extracted from the SNR indicated in the SNR indication 508 (e.g., 708, 708′, 708″ in FIG. 7; SNR(s) in FIG. 8). In aspects, the thermal noise level (e.g., 806 in FIG. 8) may be determined by subtracting the NL distortion/noise level (e.g., 808 in FIG. 8) from the SNR or corresponding EVM (e.g., 708, 708′, 708″ in FIG. 7; SNR(s) in FIG. 8).

The NL indication 512 (e.g., 814, 816 in FIG. 8) may indicate an activation or a deactivation of NL cancelation for the UE 502. The base station 504 may be configured to transmit/provide the NL indication 512 (e.g., 814, 816 in FIG. 8), which the UE 502 may be configured to receive (e.g., using a PDCCH). In aspects, the NL indication 512 (e.g., 814, 816 in FIG. 8) may indicate the deactivation of the NL cancelation for the UE 502 based on the thermal noise level (e.g., 806 in FIG. 8) associated with the PA (e.g., 602 in FIG. 6; 706 in FIG. 7; 818 in FIG. 8) of the base station 504 meeting a threshold condition (e.g., at 810 in FIG. 8), while the NL indication 512 (e.g., 814, 816 in FIG. 8) may indicate the activation of the NL cancelation for the UE 502 based on the thermal noise level (e.g., 806 in FIG. 8) associated with the base station 504 failing to meet the threshold condition (e.g., at 810 in FIG. 8), in other aspects. In some aspects, the threshold condition (e.g., at 810 in FIG. 8) may be associated with an increase to an SNR, which corresponds to the SNR indication 508 (e.g., 708, 708′, 708″ in FIG. 7; SNR(s) in FIG. 8), relative to the SNR. In aspects, the NL indication 512 (e.g., 814, 816 in FIG. 8) may indicate the deactivation of the NL cancelation for the UE 502 based on an SNR, which corresponds to the SNR indication 508 (e.g., 708, 708′, 708″ in FIG. 7; SNR(s) in FIG. 8), meeting a threshold condition (e.g., at 812 in FIG. 8), while the NL indication 512 (e.g., 814, 816 in FIG. 8) may indicate the activation of the NL cancelation for the UE 502 based on the SNR that corresponds to the SNR indication 508 (e.g., 708, 708′, 708″ in FIG. 7; SNR(s) in FIG. 8) failing to meet the threshold condition (e.g., at 812 in FIG. 8). The threshold condition (e.g., at 812 in FIG. 8) may, in such cases, be an SNR value associated with the ability of the UE 502 to properly decode a MCS utilized for communications with the base station 504.

At 906, the UE demodulates data based on the NL indication. As an example, the demodulation may be performed by one or more of the component 198, the transceiver 1122, and/or the antenna 1180 in FIG. 11. FIG. 5 illustrates an example of the UE 502 demodulating such data based on a NL indication from a network node (e.g., the base station 504).

The base station 504 may be configured to transmit/provide data 514, which the UE 502 may be configured to receive. The data 514 may be included with a transmission for the UE 502 that is received using a PDSCH. The UE 502 may be configured to activate or deactivate (at 516) NL cancelation at the UE 502 based on the NL indication 512 (e.g., 814, 816 in FIG. 8), as noted above. The UE 502 may then be configured to demodulate (at 518) the data 514 based on the NL indication 512 (e.g., 814, 816 in FIG. 8). That is, the UE 502 may be configured to demodulate (at 518) the data 514 with NL cancelation activated or with NL cancelation deactivated (as performed at 516) according to the NL indication 512 (e.g., 814, 816 in FIG. 8). In aspects where the NL indication 512 (e.g., 814, 816 in FIG. 8) indicates activation and the NL cancelation is activated (at 516), the UE may be configured to demodulate (at 518) the data based on DPoD processing at the UE 502.

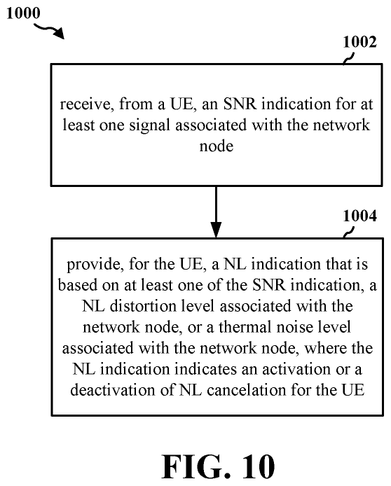

FIG. 10 is a flowchart 1000 of a method of wireless communication, in various aspects. The method may be performed by a network node (e.g., the base station 102, 504, 704, 802; the network entity 1102, 1202). In some aspects, the method may include aspects described in connection with the communication flow in FIG. 5 and/or aspects described in FIGS. 6, 7, 8. The method may be for an efficient scheme for suppression of base station NL and enables a network node (e.g., a base station, a gNB, etc.) to determine whether its power amplifier has a NL impairment based more on thermal noise or on NL distortion/noise and indicate to a UE to activate/deactivate NL cancelation accordingly, which reduces power consumption and latency in the detection process.

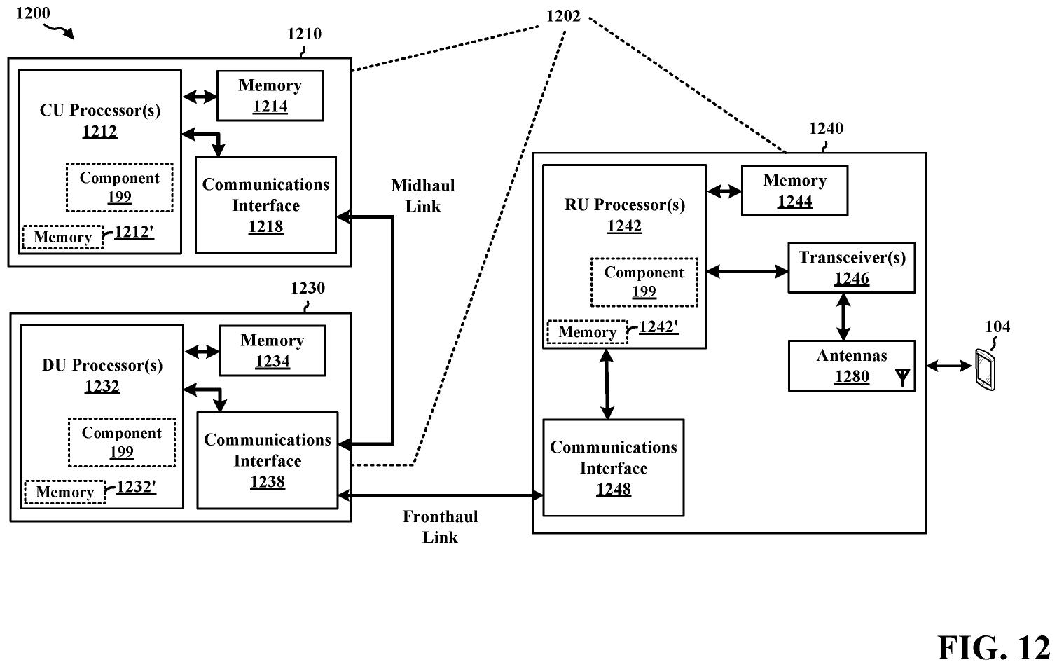

At 1002, the network node receives, from a UE, an SNR indication for at least one signal associated with the network node. As an example, the reception may be performed, at least in part, by one or more of the component 199, the transceiver(s) 1246, and/or the antenna(s) 1280 in FIG. 12. FIGS. 5-8 illustrate an example of the base station 504 receiving such an SNR indication from a UE (e.g., the UE 502).

The UE 502 may be configured to receive a signal(s) 506, which the base station 504 may be configured to transmit/provide. The UE 502 may be configured to determine/measure an SNR for the received signal(s) 506 from the base station 504. The UE 502 may then be configured to transmit/provide an SNR indication 508 (e.g., 708, 708′, 708″ in FIG. 7; SNR(s) in FIG. 8), which the base station 504 may be configured to receive. In aspects, the SNR indication 508 (e.g., 708, 708′, 708″ in FIG. 7; SNR(s) in FIG. 8) may be associated with a prior activation of NL cancelation at the UE 502. In such aspects, the SNR indication 508 (e.g., 708, 708′, 708″ in FIG. 7; SNR(s) in FIG. 8) may be associated with a corresponding quality metric that indicates an accuracy of a NL distortion level (e.g., 808 in FIG. 8) at the PA (e.g., 602 in FIG. 6; 706 in FIG. 7; 818 in FIG. 8) of the base station 504. Accordingly, the base station 504 may obtain the SNR indication 508 (e.g., 708, 708′, 708″ in FIG. 7; SNR(s) in FIG. 8) that indicates an SNR(s) for at least one signal associated therewith (e.g., the signal(s) 506).

At 1004, the network node provides, for the UE, a NL indication that is based on at least one of the SNR indication, a NL distortion level associated with the network node, or a thermal noise level associated with the network node, where the NL indication indicates an activation or a deactivation of NL cancelation for the UE. As an example, the provision may be performed, at least in part, by one or more of the component 199, the transceiver(s) 1246, and/or the antenna(s) 1280 in FIG. 12. FIGS. 5-8 illustrate an example of the base station 504 providing/transmitting such a NL indication for a UE (e.g., the UE 502).

The base station 504 may be configured to generate (at 510) a NL indication 512 (e.g., 814, 816 in FIG. 8). The NL indication 512 (e.g., 814, 816 in FIG. 8) may be generated (at 510) based on an SNR(s) indicated in the SNR indication 508 (e.g., 708, 708′, 708″ in FIG. 7; SNR(s) in FIG. 8), a thermal noise level (e.g., 806 in FIG. 8) at the base station 504 (e.g., for a PA (e.g., 602 in FIG. 6; 706 in FIG. 7; 818 in FIG. 8) of the base station 504 utilized to transmit/provide the signal(s) 506), and/or a NL distortion/noise level (e.g., 808 in FIG. 8) (e.g., for the PA (e.g., 602 in FIG. 6; 706 in FIG. 7; 818 in FIG. 8) of the base station 504). In aspects, the NL distortion level (e.g., 808 in FIG. 8) (e.g., the NL noise level) of a PA (e.g., 602 in FIG. 6; 706 in FIG. 7; 818 in FIG. 8) for the base station 504 may be configured for the base station 504 (e.g., by an OEM thereof, such as with factory calibration), may be calculated based on the SNR(s) indicated in the SNR indication 508 (e.g., 708, 708′, 708″ in FIG. 7; SNR(s) in FIG. 8), and/or may be calculated based on SNRs indicated by two or more UEs (e.g., the UE 502 and an additional UE, as described in further detail below) that have implemented NL cancelation for a signal(s) transmitted/provided by the base station 504 (e.g., these signal(s) for the SNRs may include the signal(s) 506, when NL cancelation is applied by the UE 502). The thermal noise level (e.g., 806 in FIG. 8) of a PA (e.g., 602 in FIG. 6; 706 in FIG. 7; 818 in FIG. 8) may be extracted from the SNR indicated in the SNR indication 508 (e.g., 708, 708′, 708″ in FIG. 7; SNR(s) in FIG. 8). In aspects, the thermal noise level (e.g., 806 in FIG. 8) may be determined by subtracting the NL distortion/noise level (e.g., 808 in FIG. 8) from the SNR or corresponding EVM (e.g., 708, 708′, 708″ in FIG. 7; SNR(s) in FIG. 8).

The NL indication 512 (e.g., 814, 816 in FIG. 8) may indicate an activation or a deactivation of NL cancelation for the UE 502. The base station 504 may be configured to transmit/provide the NL indication 512 (e.g., 814, 816 in FIG. 8), which the UE 502 may be configured to receive (e.g., using a PDCCH). In aspects, the NL indication 512 (e.g., 814, 816 in FIG. 8) may indicate the deactivation of the NL cancelation for the UE 502 based on the thermal noise level (e.g., 806 in FIG. 8) associated with the PA (e.g., 602 in FIG. 6; 706 in FIG. 7; 818 in FIG. 8) of the base station 504 meeting a threshold condition (e.g., at 810 in FIG. 8), while the NL indication 512 (e.g., 814, 816 in FIG. 8) may indicate the activation of the NL cancelation for the UE 502 based on the thermal noise level (e.g., 806 in FIG. 8) associated with the base station 504 failing to meet the threshold condition (e.g., at 810 in FIG. 8), in other aspects. In some aspects, the threshold condition (e.g., at 810 in FIG. 8) may be associated with an increase to an SNR, which corresponds to the SNR indication 508 (e.g., 708, 708′, 708″ in FIG. 7; SNR(s) in FIG. 8), relative to the SNR. In aspects, the NL indication 512 (e.g., 814, 816 in FIG. 8) may indicate the deactivation of the NL cancelation for the UE 502 based on an SNR, which corresponds to the SNR indication 508 (e.g., 708, 708′, 708″ in FIG. 7; SNR(s) in FIG. 8), meeting a threshold condition (e.g., at 812 in FIG. 8), while the NL indication 512 (e.g., 814, 816 in FIG. 8) may indicate the activation of the NL cancelation for the UE 502 based on the SNR that corresponds to the SNR indication 508 (e.g., 708, 708′, 708″ in FIG. 7; SNR(s) in FIG. 8) failing to meet the threshold condition (e.g., at 812 in FIG. 8). The threshold condition (e.g., at 812 in FIG. 8) may, in such cases, be an SNR value associated with the ability of the UE 502 to properly decode a MCS utilized for communications with the base station 504.

The base station 504 may be configured to transmit/provide data 514, which the UE 502 may be configured to receive. The data 514 may be included with a transmission for the UE 502 that is received using a PDSCH. The UE 502 may be configured to activate or deactivate (at 516) NL cancelation at the UE 502 based on the NL indication 512 (e.g., 814, 816 in FIG. 8), as noted above. The UE 502 may then be configured to demodulate (at 518) the data 514 based on the NL indication 512 (e.g., 814, 816 in FIG. 8). That is, the UE 502 may be configured to demodulate (at 518) the data 514 with NL cancelation activated or with NL cancelation deactivated (as performed at 516) according to the NL indication 512 (e.g., 814, 816 in FIG. 8). In aspects where the NL indication 512 (e.g., 814, 816 in FIG. 8) indicates activation and the NL cancelation is activated (at 516), the UE may be configured to demodulate (at 518) the data based on DPoD processing at the UE 502.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to provide, for a network node, an SNR indication for at least one signal associated with the network node. The component 198 may also be configured to receive, from the network node, a NL indication that is based on the SNR indication, where the NL indication indicates an activation or a deactivation of NL cancelation for the UE. The component 198 may also be configured to demodulate data based on the NL indication. The component 198 may be configured to receive the data, from the network node, using a physical downlink shared channel (PDSCH). The component 198 may be further configured to perform any of the aspects described in connection with the flowcharts in any of FIGS. 9, 10, and/or any of the aspects performed by a UE for any of FIGS. 5-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for providing, for a network node, an SNR indication for at least one signal associated with the network node. In the configuration, the apparatus 1104, and in particular the cellular baseband processor(s) 1124 and/or the application processor(s) 1106, may include means for receiving, from the network node, a NL indication that is based on the SNR indication, where the NL indication indicates an activation or a deactivation of NL cancelation for the UE. In the configuration, the apparatus 1104, and in particular the cellular baseband processor(s) 1124 and/or the application processor(s) 1106, may include means for demodulating data based on the NL indication. In one configuration, the apparatus 1104, and in particular the cellular baseband processor(s) 1124 and/or the application processor(s) 1106, may include means for receiving the data, from the network node, using a physical downlink shared channel (PDSCH). The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, an SNR indication for at least one signal associated with the network node. The component 199 may also be configured to provide, for the UE, a NL indication that is based on at least one of the SNR indication, a NL distortion level associated with the network node, or a thermal noise level associated with the network node, where the NL indication indicates an activation or a deactivation of NL cancelation for the UE. The component 199 may be configured to obtain an initial NL distortion level associated with the network node. The component 199 may be configured to obtain the thermal noise level associated with the network node based on the initial NL distortion level and the SNR indication. The component 199 may be configured to calculate the NL distortion level based on the initial NL distortion level and the thermal noise level. The component 199 may be configured to calculate the NL distortion level based on the SNR indication and the at least one additional SNR indication. The component 199 may be further configured to perform any of the aspects described in connection with the flowcharts in any of FIGS. 9, 10, and/or any of the aspects performed by a UE for any of FIGS. 5-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for receiving, from a UE, an SNR indication for at least one signal associated with the network node. In the configuration, the network entity 1202 may include means for providing, for the UE, a NL indication that is based on at least one of the SNR indication, a NL distortion level associated with the network node, or a thermal noise level associated with the network node, where the NL indication indicates an activation or a deactivation of NL cancelation for the UE. In one configuration, the network entity 1202 may include means for obtaining an initial NL distortion level associated with the network node. In one configuration, the network entity 1202 may include means for obtaining the thermal noise level associated with the network node based on the initial NL distortion level and the SNR indication. In one configuration, the network entity 1202 may include means for calculating the NL distortion level based on the initial NL distortion level and the thermal noise level. In one configuration, the network entity 1202 may include means for calculating the NL distortion level based on the SNR indication and the at least one additional SNR indication. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

For communications between network nodes (e.g., base stations, gNBs, etc.) and UEs, network nodes may provide communication signaling with NL impairments. The NL impairment at network node PA antennas is known as an impairment that limits the data transmission rate for communications. This can become more dominant in higher bands (e.g., mmW and sub-THz bands) that have poor PA efficiency (e.g., as low as 15%). Hence, when it is desired to improve this efficiency, such as by an increase of transmit power at the network node, the side effect is increased non-linearity from the transmitting PA. Some solutions with advanced receivers (e.g., at UEs) may be configured to handle distortion associated with the NL impairment with NL cancelation such as estimation and correction, which may include using DPoD or other NL cancelation strategies. However, this NL cancelation process causes power consumption and latency in the detection process at the UE. A UE may cancel NL distortion by default, regardless of the NL level with respect to the channel condition (e.g., SNR, EVM, etc.). Aspects presented herein provided added efficiency in wireless communication by enabling the UE receiver to determine whether the dominating noise floor it is experiencing is due to thermal noise or due to the NL noise. In the latter case, where NL noise is the dominant NL impairment factor, and not in the former case of thermal noise contributions, there is a benefit for the UE trying of estimating and cancelling the NL impairment. However, when the NL noise is not the dominant factor, rather thermal noise is dominant or NL noise is inconsequential, the NL cancelation process may not improve the total SNR/EVM, and the UE expends resources and time (e.g., increases power consumption and latency). Aspects presented herein enable a UE to refrain from NL correction in scenarios where it would be redundant/ineffectual and would not sufficiently improve the total SNR/EVM, e.g., when the NL impairment appears to be negligible with respect to channel conditions. Furthermore, even if the NL distortion/noise level is not negligible, but the UE receiver is able achieve an EVM (or SNR) that is sufficient to handle the current MCS decoding. NL cancelation at the UE may be unnecessary.

Various aspects herein for an efficient scheme for suppression of base station non-linearity enable network nodes to determine the actual NL distortion/noise level based on SNR indications and thermal noise levels of Pas of the network node. Indications may be provided to a UE whether to activate/deactivate NL suppression in order to apply such NL suppression for scenarios where it is beneficial and conserve UE resources/improve latency by determining an actual NL distortion/noise level based on an SNR indication(s) and a thermal noise level of the PA(s) of the network node.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: providing, for a network node, a signal-to-noise ratio (SNR) indication for at least one signal associated with the network node; receiving, from the network node, a non-linearity (NL) indication that is based on the SNR indication, wherein the NL indication indicates an activation or a deactivation of NL cancelation for the UE; and demodulating data based on the NL indication.

Aspect 2 is the method of aspect 1, wherein receiving the NL indication includes receiving the NL indication using a physical downlink control channel (PDCCH).

Aspect 3 is the method of any of aspects 1 and 2, further comprising: receiving the data, from the network node, using a physical downlink shared channel (PDSCH).

Aspect 4 is the method of any of aspects 1 to 3, wherein the NL indication indicates the activation of the NL cancelation for the UE, wherein demodulating the data includes: demodulating the data based on digital post-distortion (DPoD) processing at the UE.

Aspect 5 is the method of any of aspects 1 to 4, wherein the SNR indication is associated with a prior activation of the NL cancelation at the UE.

Aspect 6 is the method of aspect 5, wherein the SNR indication is associated with a corresponding quality metric that indicates an accuracy of a NL distortion level.

Aspect 7 is the method of any of aspects 1 to 6, wherein the NL indication is also based on at least one of a NL distortion level at the network node or a thermal noise level at the network node that are associated with at least one power amplifier (PA) of the network node.

Aspect 8 is the method of aspect 7, wherein the NL indication indicates the deactivation of the NL cancelation for the UE based on the thermal noise level associated with the network node meeting a threshold condition; or wherein the NL indication indicates the activation of the NL cancelation for the UE based on the thermal noise level associated with the network node failing to meet the threshold condition.

Aspect 9 is the method of aspect 8, wherein the threshold condition is associated with an increase to an SNR that corresponds to the SNR indication relative to the SNR.

Aspect 10 is the method of aspect 7, wherein the NL indication indicates the deactivation of the NL cancelation for the UE based on an SNR that corresponds to the SNR indication meeting a threshold condition; or wherein the NL indication indicates the activation of the NL cancelation for the UE based on the SNR that corresponds to the SNR indication failing to meet the threshold condition.

Aspect 11 is the method of aspect 10, wherein the threshold condition is an SNR value associated with properly decoding a modulation and coding scheme (MCS).

Aspect 12 is a method of wireless communication at a network node, comprising: receiving, from a user equipment (UE), a signal-to-noise ratio (SNR) indication for at least one signal associated with the network node; and providing, for the UE, a non-linearity (NL) indication that is based on at least one of the SNR indication, a NL distortion level associated with the network node, or a thermal noise level associated with the network node, wherein the NL indication indicates an activation or a deactivation of NL cancelation for the UE.

Aspect 13 is the method of aspect 12, wherein at least one of the NL distortion level at the network node or the thermal noise level at the network node are associated with at least one power amplifier (PA) of the network node.

Aspect 14 is the method of any of aspects 12 and 13, further comprising: obtaining an initial NL distortion level associated with the network node; and obtaining the thermal noise level associated with the network node based on the initial NL distortion level and the SNR indication.

Aspect 15 is the method of aspect 14, wherein the NL distortion level is configured for the network node.

Aspect 16 is the method of aspect 14, further comprising: calculating the NL distortion level based on the initial NL distortion level and the thermal noise level.

Aspect 17 is the method of aspect 16, wherein calculating the NL distortion level comprises comparing, for the at least one power amplifier (PA) of the network node, a digital representation of a transmission signal prior to power amplification with an analog representation of a power amplified output using a feedback chain.

Aspect 18 is the method of any of aspects 12 to 17, wherein receiving, from the UE, the SNR indication for the at least one signal associated with the network node comprises: receiving, from the UE and at least one additional UE based on provided grants, the SNR indication and at least one additional SNR indication, respectively, for the at least one signal associated with the network node, wherein the SNR indication and the at least one additional SNR indication are associated with a prior activation of the NL cancelation at the UE and the at least one additional UE; and wherein the method further comprises: calculating the NL distortion level based on the SNR indication and the at least one additional SNR indication.

Aspect 19 is the method of aspect 18, wherein at least one of the SNR indication and the at least one additional SNR indication is associated with at least one corresponding quality metric that indicates an accuracy of the NL distortion level; wherein the NL distortion level is a weighted average of the SNR indication and the at least one additional SNR indication based on the at least one corresponding quality metric.

Aspect 20 is the method of any of aspects 12 to 19, wherein the NL indication indicates the deactivation of the NL cancelation for the UE based on the thermal noise level associated with the network node meeting a threshold condition; or wherein the NL indication indicates the activation of the NL cancelation for the UE based on the thermal noise level associated with the network node failing to meet the threshold condition.

Aspect 21 is the method of aspect 20, wherein the threshold condition is associated with an increase to an SNR that corresponds to the SNR indication relative to the SNR.

Aspect 22 is the method of any of aspects 12 to 19, wherein the NL indication indicates the deactivation of the NL cancelation for the UE based on an SNR that corresponds to the SNR indication meeting a threshold condition; or wherein the NL indication indicates the activation of the NL cancelation for the UE based on the SNR that corresponds to the SNR indication failing to meet the threshold condition.

Aspect 23 is the method of aspect 22, wherein the threshold condition is an SNR value associated with properly decoding a modulation and coding scheme (MCS).

Aspect 24 is an apparatus for wireless communication including means for implementing any of aspects 1 to 11.

Aspect 25 is a computer-readable medium (e.g., a non-transitory computer-readable medium) storing computer executable code, the code when executed by at least one processor causes the at least one processor to implement any of aspects 1 to 11.

Aspect 26 is an apparatus for wireless communication at a network node. The apparatus includes a memory; and at least one processor coupled to the memory and, based at least in part on information stored in the memory, the at least one processor is configured to implement any of aspects 1 to 11.

Aspect 27 is the apparatus of aspect 26, further including at least one of a transceiver or an antenna coupled to the at least one processor.

Aspect 28 is an apparatus for wireless communication including means for implementing any of aspects 12 to 23.

Aspect 29 is a computer-readable medium (e.g., a non-transitory computer-readable medium) storing computer executable code, the code when executed by at least one processor causes the at least one processor to implement any of aspects 12 to 23.

Aspect 30 is an apparatus for wireless communication at a network node. The apparatus includes a memory; and at least one processor coupled to the memory and, based at least in part on information stored in the memory, the at least one processor is configured to implement any of aspects 12 to 23.

Aspect 31 is the apparatus of aspect 30, further including at least one of a transceiver or an antenna coupled to the at least one processor.

Aspect 32 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1 to 11.

Aspect 33 is an apparatus for wireless communication at a UE, comprising means for performing each step in the method of any of aspects 1 to 11.

Aspect 34 is the apparatus of any of aspects 32 and 33, further comprising a transceiver configured to receive or to transmit in association with the method of any of aspects 1 to 11.

Aspect 35 is a computer-readable medium storing computer executable code at a UE, the code when executed by at least one processor causes the at least one processor to perform the method of any of aspects 1 to 11.

Aspect 36 is an apparatus for wireless communication at a network node, comprising: at least one memory; and at least one processor coupled to the at least one memory and, based at least in part on information stored in the at least one memory, the at least one processor, individually or in any combination, is configured to perform the method of any of aspects 12 to 23.

Aspect 37 is an apparatus for wireless communication at a network node, comprising means for performing each step in the method of any of aspects 12 to 23.

Aspect 38 is the apparatus of any of aspects 36 and 37, further comprising a transceiver configured to receive or to transmit in association with the method of any of aspects 12 to 23.

Aspect 39 is a computer-readable medium storing computer executable code at a network node, the code when executed by at least one processor causes the at least one processor to perform the method of any of aspects 12 to 23.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
provide, for a network node, a signal-to-noise ratio (SNR) indication for at least one signal associated with the network node;
receive, from the network node, a non-linearity (NL) indication that is based on the SNR indication, wherein the NL indication indicates an activation or a deactivation of NL cancelation for the UE; and
demodulate data based on the NL indication.

2. The apparatus of claim 1, wherein to receive the NL indication, the at least one processor, individually or in any combination, is configured to receive the NL indication using a physical downlink control channel (PDCCH).

3. The apparatus of claim 1, wherein the at least one processor, individually or in any combination, is further configured to:
receive the data, from the network node, using a physical downlink shared channel (PDSCH).

4. The apparatus of claim 1, wherein the NL indication indicates the activation of the NL cancelation for the UE, wherein to demodulate the data, the at least one processor, individually or in any combination, is configured to:
demodulate the data based on digital post-distortion (DPoD) processing at the UE.

5. The apparatus of claim 1, wherein the SNR indication is associated with a prior activation of the NL cancelation at the UE.

6. The apparatus of claim 5, wherein the SNR indication is associated with a corresponding quality metric that indicates an accuracy of a NL distortion level.

7. The apparatus of claim 1, wherein the NL indication is also based on at least one of a NL distortion level at the network node or a thermal noise level at the network node that are associated with at least one power amplifier (PA) of the network node.

8. The apparatus of claim 7, wherein the NL indication indicates the deactivation of the NL cancelation for the UE based on the thermal noise level associated with the network node meeting a threshold condition; or
wherein the NL indication indicates the activation of the NL cancelation for the UE based on the thermal noise level associated with the network node failing to meet the threshold condition.

9. The apparatus of claim 8, wherein the threshold condition is associated with an increase to an SNR that corresponds to the SNR indication relative to the SNR.

10. The apparatus of claim 7, wherein the NL indication indicates the deactivation of the NL cancelation for the UE based on an SNR that corresponds to the SNR indication meeting a threshold condition; or
wherein the NL indication indicates the activation of the NL cancelation for the UE based on the SNR that corresponds to the SNR indication failing to meet the threshold condition.

11. The apparatus of claim 10, wherein the threshold condition is an SNR value associated with properly decoding a modulation and coding scheme (MCS).

12. The apparatus of claim 1, further comprising at least one transceiver coupled to the at least one processor, the at least one transceiver being configured to:
provide the SNR indication for the at least one signal associated with the network node; and
receive the NL indication that is based on the SNR indication.

13. An apparatus for wireless communication at a network node, comprising:
at least one memory; and
at least one processor coupled to the at least one memory and, based at least in part on information stored in the at least one memory, the at least one processor, individually or in any combination, is configured to:
receive, from a user equipment (UE), a signal-to-noise ratio (SNR) indication for at least one signal associated with the network node; and
provide, for the UE, a non-linearity (NL) indication that is based on at least one of the SNR indication, a NL distortion level associated with the network node, or a thermal noise level associated with the network node, wherein the NL indication indicates an activation or a deactivation of NL cancelation for the UE.

14. The apparatus of claim 13, wherein at least one of the NL distortion level at the network node or the thermal noise level at the network node are associated with at least one power amplifier (PA) of the network node.

15. The apparatus of claim 13, wherein the at least one processor, individually or in any combination, is further configured to:
obtain an initial NL distortion level associated with the network node; and
obtain the thermal noise level associated with the network node based on the initial NL distortion level and the SNR indication.

16. The apparatus of claim 15, wherein the NL distortion level is configured for the network node.

17. The apparatus of claim 15, wherein the at least one processor, individually or in any combination, is further configured to:
calculate the NL distortion level based on the initial NL distortion level and the thermal noise level.

18. The apparatus of claim 17, wherein to calculate the NL distortion level, the at least one processor, individually or in any combination, is configured to compare, for at least one power amplifier (PA) of the network node, a digital representation of a transmission signal prior to power amplification with an analog representation of a power amplified output using a feedback chain.

19. The apparatus of claim 13, wherein to receive, from the UE, the SNR indication for the at least one signal associated with the network node, the at least one processor, individually or in any combination, is configured to:
receive, from the UE and at least one additional UE based on provided grants, the SNR indication and at least one additional SNR indication, respectively, for the at least one signal associated with the network node, wherein the SNR indication and the at least one additional SNR indication are associated with a prior activation of the NL cancelation at the UE and the at least one additional UE; and
wherein the at least one processor, individually or in any combination, is further configured to:
calculate the NL distortion level based on the SNR indication and the at least one additional SNR indication.

20. The apparatus of claim 19, wherein at least one of the SNR indication and the at least one additional SNR indication is associated with at least one corresponding quality metric that indicates an accuracy of the NL distortion level;
wherein the NL distortion level is a weighted average of the SNR indication and the at least one additional SNR indication based on the at least one corresponding quality metric.

21. The apparatus of claim 13, wherein the NL indication indicates the deactivation of the NL cancelation for the UE based on the thermal noise level associated with the network node meeting a threshold condition; or
wherein the NL indication indicates the activation of the NL cancelation for the UE based on the thermal noise level associated with the network node failing to meet the threshold condition.

22. The apparatus of claim 21, wherein the threshold condition is associated with an increase to an SNR that corresponds to the SNR indication relative to the SNR.

23. The apparatus of claim 13, wherein the NL indication indicates the deactivation of the NL cancelation for the UE based on an SNR that corresponds to the SNR indication meeting a threshold condition; or
wherein the NL indication indicates the activation of the NL cancelation for the UE based on the SNR that corresponds to the SNR indication failing to meet the threshold condition.

24. The apparatus of claim 23, wherein the threshold condition is an SNR value associated with properly decoding a modulation and coding scheme (MCS).

25. The apparatus of claim 13, further comprising at least one transceiver coupled to the at least one processor, the at least one transceiver being configured to:
receive the SNR indication for the at least one signal associated with the network node; and
provide the NL indication.

26. A method of wireless communication at a user equipment (UE), comprising:
providing, for a network node, a signal-to-noise ratio (SNR) indication for at least one signal associated with the network node;
receiving, from the network node, a non-linearity (NL) indication that is based on the SNR indication, wherein the NL indication indicates an activation or a deactivation of NL cancelation for the UE; and
demodulating data based on the NL indication.

27. The method of claim 26, wherein the NL indication indicates the activation of the NL cancelation for the UE, wherein demodulating the data includes:
demodulating the data based on digital post-distortion (DPoD) processing at the UE.

28. A method of wireless communication at a network node, comprising:
receiving, from a user equipment (UE), a signal-to-noise ratio (SNR) indication for at least one signal associated with the network node; and
providing, for the UE, a non-linearity (NL) indication that is based on at least one of the SNR indication, a NL distortion level associated with the network node, or a thermal noise level associated with the network node, wherein the NL indication indicates an activation or a deactivation of NL cancelation for the UE.

29. The method of claim 28, wherein at least one of the NL distortion level at the network node or the thermal noise level at the network node are associated with at least one power amplifier (PA) of the network node; or
wherein the method further comprises:
obtaining an initial NL distortion level associated with the network node; and
obtaining the thermal noise level associated with the network node based on the initial NL distortion level and the SNR indication.

30. The method of claim 29, wherein the NL distortion level is configured for the network node; or
wherein the method further comprises:
calculating the NL distortion level based on the initial NL distortion level and the thermal noise level, wherein calculating the NL distortion level comprises comparing, for the at least one power amplifier (PA) of the network node, a digital representation of a transmission signal prior to power amplification with an analog representation of a power amplified output using a feedback chain.
